(19) United States
(12) Patent Application Publication
(10) Pub. No.: US 2010/0070612 A1
(43) Pub. Date: Mar. 18, 2010

(54) INFORMATION PROCESSING SYSTEM, COMMUNICATION CONTROL APPARATUS AND COMPUTER READABLE MEDIUM

(75) Inventor: Shoji SAKAMOTO, Ashigarakami-gun (JP)

Correspondence Address: SUGHRUE-265550, 2100 PENNSYLVANIA AVE. NW, WASHINGTON, DC, 20037-3213, US

(73) Assignee: Fuji Xerox Co., Ltd.,, Tokyo (JP)

(21) Appl. No.: 12/406,508

(22) Filed: Mar. 18, 2009

(30) Foreign Application Priority Data
Sep. 16, 2008 (JP) 2008-236143

(51) Int. Cl. G06F 15/16; G06F 17/00

(52) U.S. Cl. 709/219; 700/94

(57) ABSTRACT

An information processing system includes first to third information processing apparatuses and a communication control apparatus that controls communications among the first to third information processing apparatuses. The communication control apparatus includes: an acquisition unit that acquires information concerning a communication quality between the first and second information processing apparatuses; a setting unit that sets communications between the first and third information processing apparatus based on the information concerning the communication quality acquired by the acquisition unit; and a transfer unit that transfers information transmitted from the first information processing apparatus to the second information processing apparatus, to the third information processing apparatus as well as the second information processing apparatus. Each of the first to third information processing apparatuses includes a playing unit that plays information transmitted from each of the first to third information processing apparatuses.

### CROSS-REFERENCE TO RELATED APPLICATIONS

This application is based on and claims priority under 35 USC 119 from Japanese Patent Application No. 2008-236143 filed Sep. 16, 2008.

### BACKGROUND

1. Technical Field

This invention relates to an information processing system, a communication control apparatus, and a computer readable medium.

2. Related Art

Data communication technology through a network develops, and a system for transmitting and receiving multimedia between remote locations and communicating between the users becomes widespread. In such a system, a data loss or a communication delay may occur depending on the communication environment of the party at the other end, and interaction between the users may go wrong.

### SUMMARY

According to an aspect of the invention, an information processing system includes: a first information processing apparatus; a second information processing apparatus; a third information processing apparatus; and a communication control apparatus that controls communications among the first to third information processing apparatuses.

The communication control apparatus includes: an acquisition unit that acquires information concerning a communication quality between the first and second information processing apparatuses; a setting unit that sets communications between the first and third information processing apparatus based on the information concerning the communication quality acquired by the acquisition unit; and a transfer unit that transfers information transmitted from the first information processing apparatus to the second information processing apparatus, to the third information processing apparatus as well as the second information processing apparatus. Each of the first to third information processing apparatuses includes a playing unit that plays information transmitted from each of the first, second and third information processing apparatuses.

### BRIEF DESCRIPTION OF THE DRAWINGS

Exemplary embodiment(s) of the present invention will be described in detail based on the following figures, wherein:

FIG. 1 is a system block diagram of an information processing system according to an exemplary embodiment of the invention;

FIG. 2 is a functional block diagram of the information processing system; and

FIG. 3 is a sequence chart of a processing example in the information processing system.

### DETAILED DESCRIPTION

An exemplary embodiment for carrying out the invention (simply, exemplary embodiment) will be discussed with reference to the accompanying drawings.

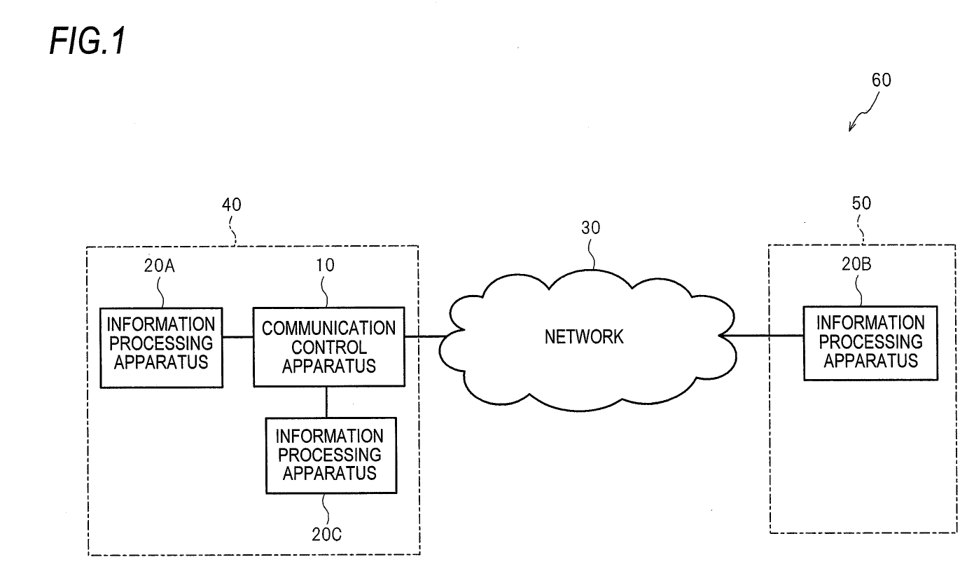

FIG. 1 is a system block diagram of an information processing system 60 according to an exemplary embodiment of the invention. As shown in FIG. 1, the information processing system 60 includes information processing apparatuses 20A, 20B and 20C and a communication control apparatus 10. The information processing apparatuses 20A and 20C and the communication control apparatus 10 are included in a local system 40, and the information processing apparatus 20B is included in a local system 50. The local systems 40 and 50 may exist at remote locations and are connected through a network 30 such as the Internet. The apparatus included in the local system 40 and the apparatus included in the local system 50 can communicate with each other through the network 30.

Communications between the information processing apparatuses 20 (the information processing apparatuses 20A, 20B and 20C are referred to “information processing apparatus(es) 10” when it is not necessary to discriminate thereamon) are conducted through the communication control apparatus 10. In the exemplary embodiment, when a first user using the information processing apparatus 20A and a second user using the information processing apparatus 20B interact with each other through the network 30, the information processing apparatus 20C emulates and plays information transmitted from the information processing apparatus 20A, which is played in the information processing apparatus 20B. The configuration of each apparatus will be discussed below.

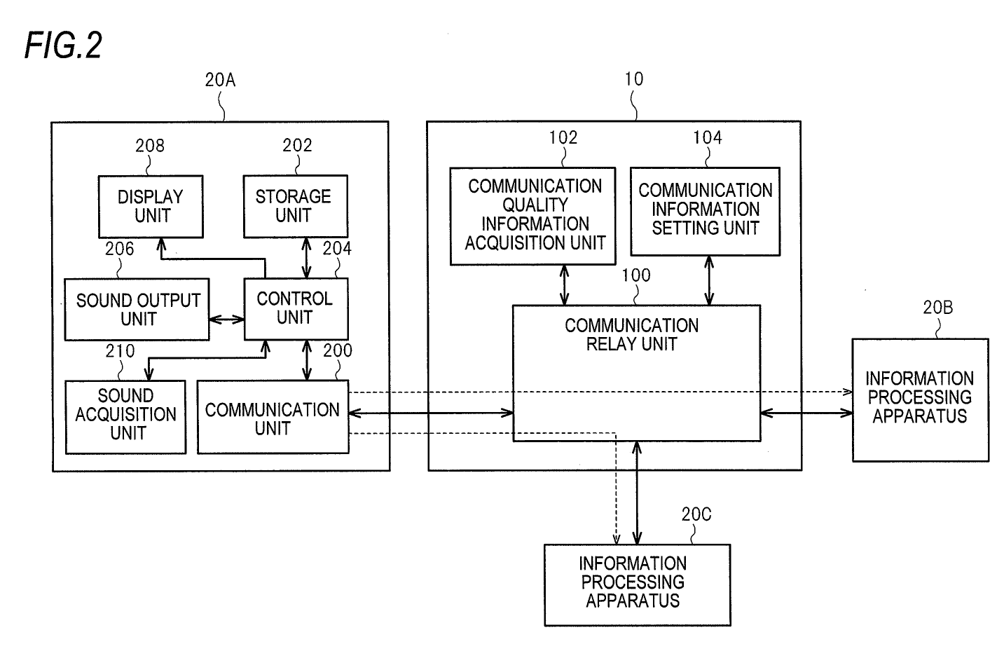

FIG. 2 is a functional block diagram of the communication control apparatus 10 and the information processing apparatus 20A included in the information processing system 60. In the exemplary embodiment, the configurations of the information processing apparatuses 20B and 20C are the same as the configuration of the information processing apparatus 20A and will not be discussed again in detail.

As shown in FIG. 2, the information processing apparatus 20A includes a communication unit 200, a storage unit 202, a control unit 204, a sound output unit 206, a display unit 208, and a sound acquisition unit 210. The functions of the units may be implemented as a program stored on a computer-readable information storage medium is read through a medium reader (not shown) into the information processing apparatus 20A of a computer system and is executed. The program may be supplied to the information processing apparatus 20A using an information storage medium or may be supplied through a data communication network such as the Internet.

The communication unit 200 contains a network interface and conducts data communications with any other information processing apparatuses 20 and the communication control apparatus 10.

The storage unit 202 contains a storage device of semiconductor memory, a magnetic disk, etc., and stores data and programs. The programs stored in the storage unit 202 contain an application program for transmitting multimedia data containing sound data of the user of each information processing apparatus 20 to the information processing apparatus 20 of the communicating party and receiving multimedia data from the information processing apparatus 20 of the communicating party and playing the multimedia data. The storage unit 202 is also used as work memory of the control unit 204 described below.

The control unit 204 contains a central processing unit (CPU) and controls the units of the information processing apparatus 20 and also processes data in accordance with the program stored in the storage unit 202. The control unit 204 processes the multimedia data received from any other information processing apparatuses 20 through the communication unit 200 in accordance with the application program, generates sound data and graphic data, and outputs the sound data and the graphic data to the sound output unit 206 and the display unit 208.

The sound output unit 206 contains a loudspeaker and outputs a sound in accordance with the sound data input from the control unit 204.

The display unit 208 displays an image on a display based on the graphic data input from the control unit 204.

The sound acquisition unit 210 contains a sound collecting device of a microphone, etc., acquires sound of the user, and generates sound data.

In the exemplary embodiment, it is assumed that the user of the information processing apparatus 20A and the user of the information processing apparatus 20B interact with each other and that the information processing apparatus 20A and the information processing apparatus 20B transmit and receive multimedia data containing sound data and image data of each user to and from each other.

Next, the configuration of the communication control apparatus 10 will be discussed. The communication control apparatus 10 is an apparatus for relaying the communications between the information processing apparatus and controlling the band of the communications and the communication performance of the delay time of the communications, etc.

As shown in FIG. 2, the communication control apparatus 10 includes a communication relay unit 100, a communication quality information acquisition unit 102, and a communication information setting unit 104. The functions of the units may be implemented as a program stored on a computer-readable information storage medium is read through a medium reader (not shown) into the communication control apparatus 10 of a computer system and is executed. The program may be supplied to the communication control apparatus 10 using an information storage medium or may be supplied through a data communication network such as the Internet.

The communication relay unit 100 transfers data received from the information processing apparatus 20 to the network 30 or the apparatus in the local system in response to the destination of the data. In the exemplary embodiment, the communication relay unit 100 relays communications between the information processing apparatus 20A and 20B and communications between the information processing apparatus 20A and 20C.

The communication quality information acquisition unit 102 measures and acquires information of the communication quality about the data communications between the information processing apparatuses 20. In the exemplary embodiment, for the data communications conducted between the information processing apparatuses 20A and 20B, the communication quality information acquisition unit 102 measures and acquires information of the delay time of data transfer occurring until data transmitted from one information processing apparatus 20 arrives at the other information processing apparatus 20, the packet loss rate (transmission error rate) of the data transmission, etc.

The communication information setting unit 104 sets a communication parameter of a communication path for relaying in the communication relay unit 100 based on the communication quality information acquired by the communication quality information acquisition unit 102. Specifically, the communication information setting unit 104 sets a communication parameter to be set in the communication path between the information processing apparatus 20A and the information processing apparatus 20C that emulates the environment of the information processing apparatus 20B. The communication parameter is set based on the delay time and the packet loss rate acquired about the communications between the information processing apparatus 20A and 20B.

The communication relay unit 100 also transmits multimedia data transmitted from the information processing apparatus 20A to the information processing apparatus 20B, for example, to the information processing apparatus 20C according to the communication quality based on the delay time and the packet loss rate set as mentioned above. The communication control apparatus 10 thus constructs the communication environment emulating the communications between the information processing apparatuses 20A and 20B, actual data communications are conducted between the information processing apparatuses 20A and 20C.

The information processing apparatus 20C receives and plays the data transmitted from the information processing apparatus 20A to the information processing apparatus 20B at almost the same timing as the information processing apparatus 20B. Thus, the user of the information processing apparatus 20A checks the playing mode of the information processing apparatus 20B based on the playing mode in the information processing apparatus 20C.

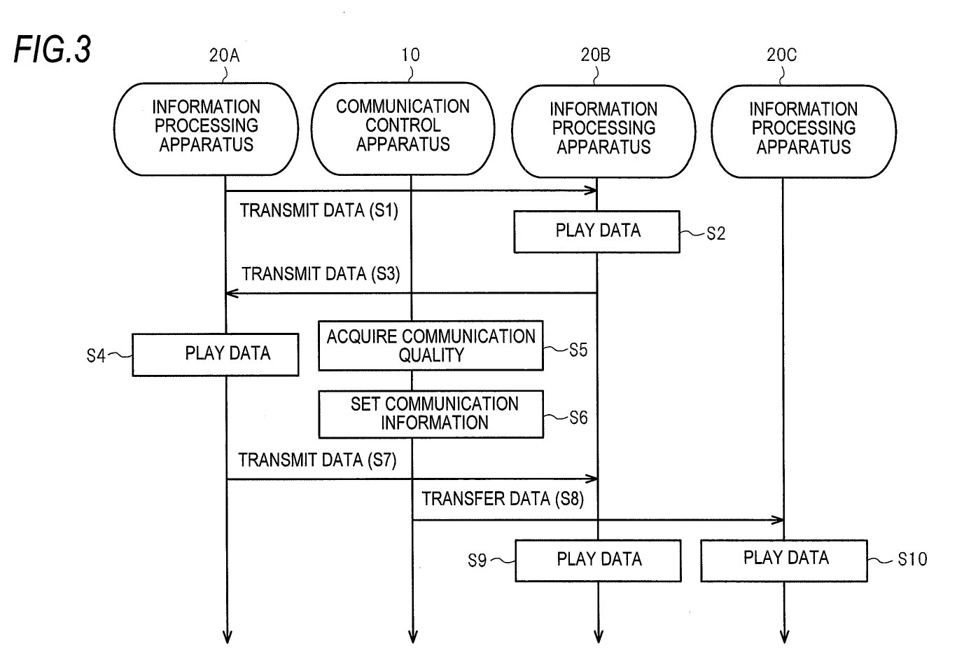

Next, a processing flow in the apparatus of the information processing system 60 according to the exemplary embodiment will be discussed with reference to a sequence chart of FIG. 3.

It is assumed that the information processing apparatus 20A and 20B are in a data communication state in accordance with the application program. The information processing apparatus 20B receives data transmitted by the information processing apparatus 20A (S1) and plays the data (S2). Likewise, the information processing apparatus 20A receives data transmitted by the information processing apparatus 20B (S3) and plays the data (S4).

The communications between the information processing apparatus 20A and 20B are relayed by the communication control apparatus 10. The communication control apparatus 10 acquires information indicating the communication quality, such as the delay time and the packet loss rate, for the communications conducted between the information processing apparatus 20A and 20B (S5). The communication control apparatus 10 sets communication information (communication parameter) between the information processing apparatuses 20A and 20C based on the acquired information of the communication quality between the information processing apparatuses 20A and 20B (S6).

Next, the communication control apparatus 10 also transfers the data transmitted and received between the information processing apparatuses 20A and 20B to the information processing apparatus 20C. That is, the communication control apparatus 10 receives data transmitted from the information processing apparatus 20A (S7) and transmits the received data to the information processing apparatus 20B and also transfers the data to the information processing apparatus 20C (S8). Thus, the data are played almost at the same timing between the information processing apparatuses 20B and 20C (S9 and S10).

The user of the information processing apparatus 20A checks a screen and sound played in the information processing apparatus 20B based on a screen and sound played in the information processing apparatus 20C. A computer of the same specifications as the information processing apparatus 20B is used for the information processing apparatus 20C, whereby the playing mode of the information processing apparatus 20B is played in a closer mode as compared with the case where a computer of different specifications is used.

In the information processing system 60 according to the exemplary embodiment described above, the communication environment between the information processing apparatuses 20A and 20B is emulated between the information processing apparatus 20A and 20C, whereby playing of the information transmitted by the information processing apparatus 20A in the environment of the information processing apparatus 20B of the communicating party is played in the information processing apparatus 20C. It is to be understood that the invention is not limited to the specific exemplary embodiment described above and that it is obvious to those skilled in the art that various changes, modifications, or replacement may be made, of course.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a first information processing apparatus;
a second information processing apparatus;
a third information processing apparatus; and
a communication control apparatus that controls communications among the first to third information processing apparatuses,
wherein
the communication control apparatus comprises:
an acquisition unit that acquires information concerning a communication quality between the first and second information processing apparatuses;
a setting unit that sets communications between the first and third information processing apparatus based on the information concerning the communication quality acquired by the acquisition unit; and
a transfer unit that transfers information transmitted from the first information processing apparatus to the second information processing apparatus, to the third information processing apparatus as well as the second information processing apparatus, and
each of the first, second and third information processing apparatuses comprises:
a playing unit that plays information transmitted from each of the first, second and third information processing apparatuses.

2. The information processing system according to claim 1 wherein
the acquisition unit acquires the information concerning the communication quality between the first and second information processing apparatuses in sequence at previously determined time intervals, and
the setting unit sets the communications between the first and third information processing apparatus in sequence in response to the information concerning the communication quality acquired in sequence by the acquisition unit.

3. A communication control apparatus comprising:
a relay unit that relays communications among first to third information processing apparatus;
an acquisition unit that acquires information concerning the communication quality between the first and second information processing apparatus;
a setting unit that sets the communications between the first and third information processing apparatus based on the information concerning the communication quality acquired by the acquisition unit; and
a transfer unit that transfers information transmitted from the first information processing apparatus to the second information processing apparatus, to the third information processing apparatus as well as the second information processing apparatus.

4. A computer readable medium storing a program causing a computer to execute a process for controlling communications, the process comprising:
relaying communications among first to third information processing apparatus;
acquiring information concerning the communication quality between the first and second information processing apparatus;
setting the communications between the first and third information processing apparatus based on the acquired information concerning the communication quality; and
transferring information transmitted from the first information processing apparatus to the second information processing apparatus, to the third information processing apparatus as well as the second information processing apparatus.
